(19) United States
(12) Patent Application Publication
(10) Pub. No.: US 2026/0258805 A1
(43) Pub. Date: Sep. 3, 2026

(54) SIROCCO FAN

(71) Applicant: LG ELECTRONICS INC., Seoul (KR)

(72) Inventors: Sanghyuk SON, Seoul (KR); Dongkeun YANG, Seoul (KR)

(73) Assignee: LG ELECTRONICS INC., Seoul (KR)

(21) Appl. No.: 18/993,197

(22) PCT Filed: Jun. 15, 2023
(86) PCT No.: PCT/KR2023/008282

§ 371 Date: Jan. 10, 2025

(30) Foreign Application Priority Data
Jul. 13, 2022 (KR) 10-2022-0086237

(51) Int. Cl. F04D 17/04; F04D 29/42; F04D 29/44

(52) U.S. Cl. CPC F04D 17/04; F04D 29/4226; F04D 29/441

(57) ABSTRACT

The sirocco fan according to an embodiment of the present invention includes a scroll housing forming a recessed portion for accommodating a fan, and the scroll housing may include a flow guide device to prevent radial vortex from occurring at an end of the fan.

### TECHNICAL FIELD

The present invention relates to a sirocco fan.

### BACKGROUND ART

Generally, a sirocco fan can be used in an air conditioner or an air cleaner. The sirocco fan is a type of centrifugal fan that sucks air in an axial direction and discharges it in a radial direction in a circumferential direction.

The sirocco fan may include a plurality of blades arranged in a circumferential direction and a scroll that accommodates the plurality of blades. The scroll may perform a function of collecting a radial dynamic pressure component generated from the fan in a single direction and converting it into a static pressure component.

A gap is formed between a fan, which is a rotating body and a fixed scroll and a gap, and a problem may arise in which a vortex occurs in the flow discharged from the fan or an unwanted flow disturbance occurs in this gap. The vortex may cause a flow loss and a problem in which the fan efficiency is reduced.

### DETAILED DESCRIPTION OF THE INVENTION

### Technical Problem

The present invention provides a sirocco fan including a flow guide device to prevent unwanted disturbance flow from occurring in the flow discharged through a fan in order to solve the above problems.

The present invention provides a sirocco fan including a flow guide device arranged adjacent to a radial end of the fan so that some of the radial discharge flow discharged to the outside of the fan can prevent the vortex from returning to the inside of the fan.

The present invention provides a sirocco fan including a flow guide device including at least one of a protrusion and a groove in order to improve the fluidity performance of the fan.

The present invention provides a sirocco fan in which a rotating fan is placed on a fixed bottom surface of a scroll housing and at least one of a rib and having a groove formed circumferentially on the bottom surface of the scroll so that a radial vortex can be prevented in a gap between the scroll housing and the fan.

The present invention provides a sirocco fan in which the ribs include a plurality of ribs and the heights of the plurality of ribs are formed differently in order to prevent the occurrence of a radially inward vortex in the discharge flow of the fan.

### Technical Solution

In order to solve the above-mentioned problem, the sirocco fan according to an embodiment of the present invention includes a scroll housing forming a recessed portion for accommodating the fan, and the scroll housing may include a flow guide device to prevent the occurrence of a radially inward vortex at an end of the fan.

The flow guide device may be arranged adjacent to a radially outermost end of the fan to prevent the occurrence of a radially inward vortex of the fan.

The scroll housing includes a fixed bottom surface on which the rotating fan part is placed, and a flow guide device may be provided on the bottom surface to prevent the occurrence of the radially inward vortex in a gap between the fan and the bottom surface.

The flow guide device may include a rib protruding from the bottom surface in a direction approaching the fan.

The ribs may be formed in the circumferential direction of the fan so as to form a flow in the circumferential direction and prevent the occurrence of the vortex in the radial direction.

The ribs may include a plurality of ribs.

The plurality of ribs may include two or more ribs protruding at different heights.

One rib provided at the outermost side in the radial direction among the plurality of ribs may have a greater protruded height than the other ribs.

The flow guide device may include a groove that is recessed in a direction away from the fan on the bottom surface.

The groove may be formed in the circumferential direction of the fan so as to form a flow in the circumferential direction and prevent the occurrence of the vortex in the radial direction.

The groove may include a plurality of grooves.

The flow guide device may include a plurality of ribs that protrude in a direction approaching the fan from the bottom surface and a plurality of grooves that are recessed in a direction away from the fan on the bottom surface.

The plurality of ribs and the plurality of grooves may be arranged alternately in the radial direction.

Any one of the plurality of ribs may be arranged to surround any one of the plurality of grooves.

Any one of the plurality of grooves may be arranged to surround any one of the plurality of ribs.

A sirocco fan according to an embodiment of the present invention may include a scroll housing having a bottom surface and forming an axial suction portion and a radial discharge portion and a fan including a plurality of blades arranged on the bottom surface of the scroll housing and arranged in a circumferential direction.

The sirocco fan may include a fan motor having a motor shaft coupled to the fan and a flow guide device provided in a spaced space between the bottom surface and the fan.

The flow guide device may be formed in a circumferential direction so as to suppress the occurrence of flow toward the center of the fan among air flowing toward the discharge portion.

The fan may include a main plate coupled to the motor shaft, and the flow guide device may be provided between the main plate of the fan and the bottom surface of the scroll housing.

The plurality of blades may be arranged in the circumferential direction of the main plate, and the flow guide device may be provided at a position adjacent to the edge of the main plate or adjacent to the radially outermost end of the plurality of blades.

The flow guide device may include a rib provided on the bottom surface of the scroll housing and protruding toward the main plate of the fan, and the rib may extend circumferentially along the edge of the fan.

The rib may include a plurality of ribs extending in a circumferential direction, and at least one rib among the plurality of ribs may be provided further outward than the radially outermost end of the fan, and the other rib may be provided further inward than the radially outermost end of the fan.

The plurality of ribs may include a first rib extending in the circumferential direction and a second rib surrounding the first rib and extending in the circumferential direction.

The flow guide device includes a groove formed on the bottom surface of the scroll housing and recessed in a direction away from the main plate of the fan, and the groove may be formed in the circumferential direction of the fan.

The groove may include a plurality of grooves formed in the circumferential direction, and at least one groove among the plurality of grooves may be formed further outward than the radially outermost end of the fan, and the other groove may be formed further inward than the radially outermost end of the fan.

The plurality of grooves may include a first groove formed in the circumferential direction and a second groove surrounding the first groove and formed in the circumferential direction.

The flow guide device may include a plurality of ribs provided on the bottom surface of the scroll housing and protruding toward the main plate of the fan and a plurality of grooves recessed in the bottom surface of the scroll housing.

The plurality of ribs and the plurality of grooves may be arranged alternately in the radial direction.

The plurality of ribs may include a first rib and a second rib extending in the circumferential direction, and the plurality of grooves may include a first groove formed in the circumferential direction between the first and second ribs.

When defining an axial extension line ( [symbol] 1) passing through the radially outermost portion of the fan, the axial extension line may be configured to pass through the flow guide device.

The extension line ( [symbol] 1) may be located radially inner side than a rib provided in the outermost portion of the fan, and may be configured to pass through any one of the grooves of the plurality of grooves.

The scroll housing may include a recessed portion recessed from the suction portion to accommodate the fan, and the recessed portion may include a scroll inner circumferential portion surrounding the fan and a lower surface defining the bottom surface.

The scroll housing may include a discharge guide extending in a tangential direction from the inner circumferential portion of the scroll to the fan, and a cut-off formed at a portion where the scroll inner circumferential portion of the scroll and the discharge guide meet and defining a boundary between a discharge and re-suction of air flow.

In another aspect, the sirocco fan may include a scroll housing forming an axial suction portion and a radial discharge portion and having a bottom surface and a fan provided on the bottom surface of the scroll housing and including a plurality of blades arranged in the circumferential direction.

The sirocco fan may include a plurality of ribs provided in a space between the bottom surface and the fan and arranged in the circumferential direction so as to suppress the occurrence of a flow toward the center of the fan among air flowing toward the discharge portion.

The sirocco fan may include a groove formed between the plurality of ribs.

The plurality of ribs may protrude axially from the bottom surface toward the fan.

The plurality of ribs may be provided in an edge area of the fan.

The plurality of ribs may include a first rib extending in the circumferential direction of the fan and a second rib surrounding the first rib and extending in the circumferential direction of the fan.

The second rib may be provided outward than the radially outermost end of the fan, and the first rib may be provided further inward than the radially outermost end of the fan.

The height at which the first rib protrudes from the bottom surface may be greater than the height at which the second rib protrudes from the bottom surface.

### Effect of the Invention

According to an embodiment of the present invention, since the flow guide device is provided in a sirocco fan, it is possible to prevent unwanted disturbance flow from occurring in the flow discharged through the fan and reduce flow loss.

According to an embodiment of the present invention, since the flow guide device is provided adjacent to a radially end of the fan, it is possible to prevent a portion of the flow discharged in the radial direction toward the outside of the fan from returning to the inside of the fan.

According to an embodiment of the present invention, since the flow guide device including at least one of the protrusion and the groove is provided, the flow performance of the fan can be improved.

According to an embodiment of the present invention, since a rotating fan is placed on a fixed bottom surface of a scroll housing and at least one of the ribs and grooves is provided in the circumferential direction on the bottom surface, a radial vortex in the gap between the scroll housing and the fan can be prevented.

According to an embodiment of the present invention, since the rib includes a plurality of ribs and the heights of the plurality of ribs are formed differently, it may prevent radially inward vortex in the discharge flow of the fan.

### BRIEF DESCRIPTION OF THE DRAWINGS

FIG. 1 is a perspective view showing the configuration of a sirocco fan according to an embodiment of the present invention.

FIG. 2 is an exploded perspective view showing the configuration of the sirocco fan according to an embodiment of the present invention.

FIG. 3 is a cross-sectional view taken along line 3-3′ of FIG. 1.

FIG. 4 is a perspective view showing the configuration of the scroll housing according to an embodiment of the present invention.

FIG. 5 is a cross-sectional view showing a part of the configuration of the sirocco fan including the arrangement of the scroll housing and the fan according to an embodiment of the present invention.

FIG. 6 is a cross-sectional view showing a state in which a flow guide device is provided in a gap between a bottom surface of the scroll housing and a bottom surface of the fan according to an embodiment of the present invention.

FIG. 7 is a plan view showing a flow state in the sirocco fan according to an embodiment of the present invention.

FIG. 8 is a cross-sectional view showing a flow state in a circumferential direction through the flow guide device according to an embodiment of the present invention.

FIG. 9a is a cross-sectional view showing a flow state in a sirocco fan not provided with a flow guide device according to an embodiment of the present invention.

FIG. 9b is a cross-sectional view showing a flow state in a sirocco fan provided with a flow guide device according to an embodiment of the present invention.

FIG. 10a is an experimental graph showing a comparison between a sirocco fan (comparative group) according to FIG. 9a and the sirocco fan according to the present invention with respect to a change in airflow volume relative to the rotational speed of the fan.

FIG. 10b is an experimental graph showing a comparison between a sirocco fan (comparative group) according to FIG. 9a and the sirocco fan according to the present invention with respect to a change in power consumption relative to the airflow volume of the fan.

### MODE FOR INVENTION

Hereinafter, some embodiments of the present invention will be described in detail through exemplary drawings. When adding reference numerals to components in each drawing, it should be noted that the same components are given the same numerals as much as possible even if they are shown in different drawings. In addition, when describing embodiments of the present invention, if it is determined that a specific description of a related known configuration or function interferes with the understanding of the embodiments of the present invention, the detailed description thereof will be omitted.

In addition, when describing components of embodiments of the present invention, terms such as first, second, A, B, (a), (b), etc. may be used. These terms are only intended to distinguish the components from other components, and the nature, order, or sequence of the components are not limited by the terms. When a component is described as being “connected,” “coupled,” or “linked” to another component, it should be understood that the component may be directly connected or linked to the other component, but another component may also be “connected,” “coupled,” or “linked” between each component.

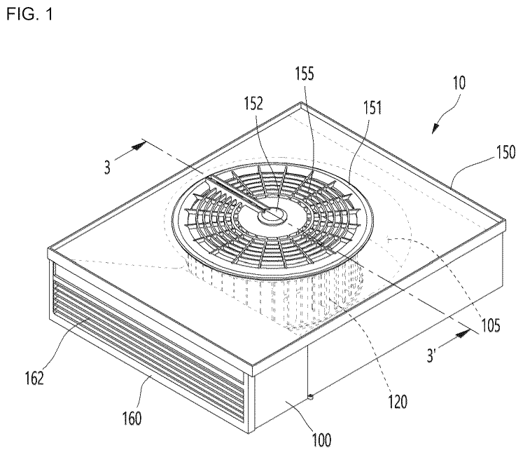

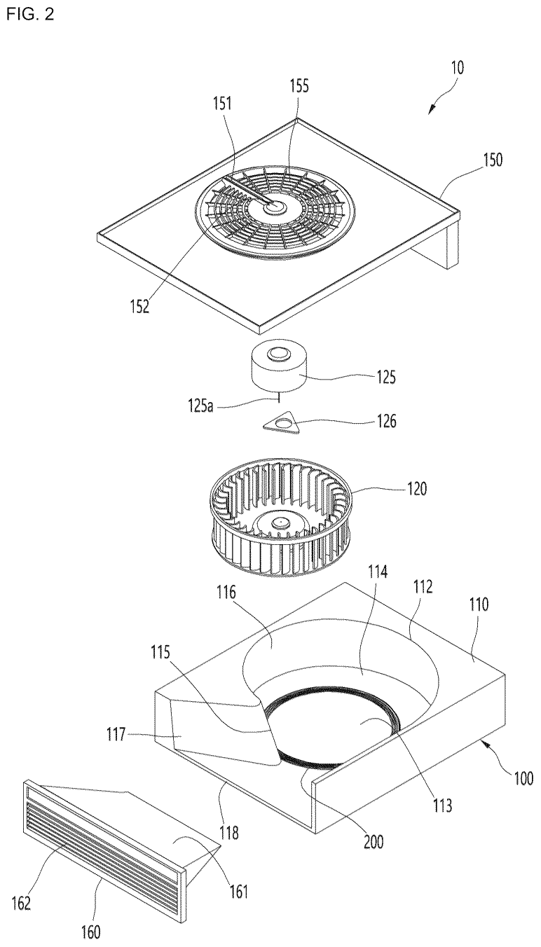

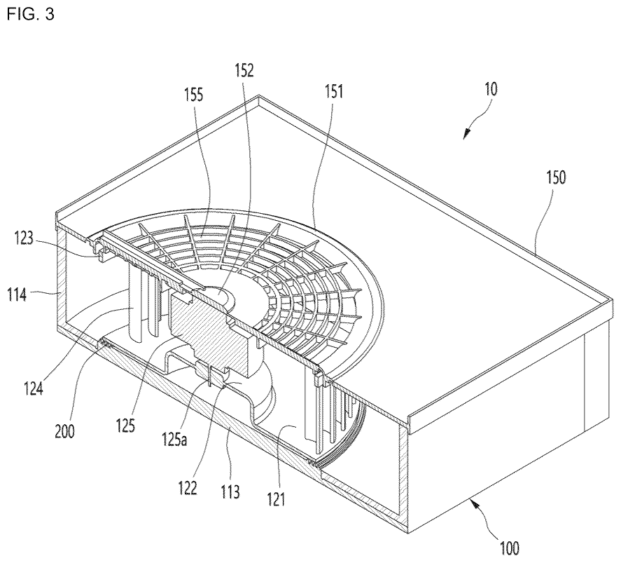

FIG. 1 is a perspective view showing the configuration of a sirocco fan according to an embodiment of the present invention, FIG. 2 is an exploded perspective view showing the configuration of the sirocco fan according to an embodiment of the present invention, and FIG. 3 is a cross-sectional view taken along line 3-3′ of FIG. 1.

Referring to FIGS. 1 to 3, a sirocco fan 10 according to an embodiment of the present invention may include a fan assembly that generates airflow and a scroll housing 100 that guides air suction to the fan assembly and guides discharge of airflow generated by driving the fan assembly.

The fan assembly may include a fan 120 that generates airflow and a fan motor 125 that drives the fan 120. The fan 120 may be coupled to a motor shaft 125a of the fan motor 125 and rotate.

A fixing bracket 126 may be provided between the mutually facing coupling surfaces of the fan motor 125 and the fan 120 to firmly couple the fan motor 125 and the fan 120. A bracket hole through which the motor shaft 125a can pass may be formed in the fixing bracket 126.

The scroll housing 100 may include a housing body 110 having an open top to accommodate the fan assembly. The housing body 110 may include a recessed portion 112 that recesses downward from the top, and may form an accommodation space for the fan assembly by the recessed portion 112.

The scroll housing 100 may include a scroll inner circumferential portion 116 arranged to surround an outer circumferential portion of a fan 120 of the fan assembly, and a discharge guide 117 extending from the scroll inner circumferential portion 116 in a tangential direction of the fan 120.

A fan path 105 may be formed between the scroll inner circumferential portion 116 and the outer circumferential surface of the fan 120 to discharge air that has passed through the fan 120.

The scroll housing 100 may form a discharge portion 118 for discharging air that has passed through the fan 120 to the outside of the sirocco fan 100. The discharge portion 118 may be formed at an outer end of the scroll discharge guide 117.

The scroll housing 100 may include a cut-off 115 defining a boundary surface between the discharge and re-intake of air flow. The cut-off 115 may be formed at a portion where the scroll inner circumferential portion 116 and the discharge guide 117 meet.

The scroll housing 110 may be configured to form a spiral in the direction in which the fan 120 rotates along the scroll inner circumferential portion 116 from the cut-off 115.

The radial distance from the motor shaft 125a to the scroll outer circumferential portion 120 in the direction in which the fan 120 rotates may be formed to gradually increase.

The sirocco fan 10 includes a cover 150 provided on one side of the scroll housing 100. The cover 150 may be arranged to overlap the recessed portion 112.

However, the cover 150 does not shield the recessed portion 112, and the exterior of the sirocco fan 10 can be fluidly connected to the interior of the sirocco fan 10, i.e., the fan assembly, through the cover 150.

An orifice 151 forming a suction portion 155 can be formed in the cover 150. The orifice 151 can have a shape corresponding to the suction side end of the fan 120. For example, the orifice 151 can have a shape of a disc.

The suction portion 155 is configured to be opened for intake of external air. The orifice 151 forms a suction grill, and the suction grill may define the suction portion 155.

The suction portion 155 can be formed on one axial side of the fan 120. Therefore, the air introduced through the suction part 155 can be sucked in the axial direction of the fan 120.

The orifice 151 may include a motor mounting part 152 on which the fan motor 125 of the fan assembly is supported. The motor mounting part 152 is approximately provided at the center of the orifice 151 and may be formed to be recessed upward with respect to FIG. 1 so that the end of the fan motor 125 can be inserted.

In this embodiment, the scroll housing 100 and the cover 150 are described as separate components, but the cover 150 forming the suction part 155 may be understood as a component of the scroll housing in a broad meaning.

The sirocco fan 10 may include an outlet flow path 161 supported on the bottom surface of the scroll housing 100. The outlet flow path 161 may have a side surface corresponding to the shape of the discharge guide 117 so as to be in contact with or adjacent to the outer end of the discharge guide 117 from the cut-off 115.

The sirocco fan 10 may include a discharge grill 160 provided in the discharge portion 118 and configured to discharge air passing through the fan flow path 105 to the outside of the scroll housing 100.

The discharge grill 160 may be provided on the discharge side of the outlet flow path 161. The discharge grill 160 may form one surface of the discharge side of the sirocco fan 10.

The fan part 120 may include a main plate 121 coupled to the motor shaft 125a. The main plate 121 may have, for example, a disc shape.

The main plate 121 may include a shaft connecting portion 122 that is coupled to the motor shaft 125a and provides rotational force to the fan 120. The shaft connecting portion 122 may be arranged approximately at the center of the main plate 121.

The shaft connecting portion 122 may protrude from the edge of the main plate 121 in a direction (upward in FIG. 3) toward the fan motor 125.

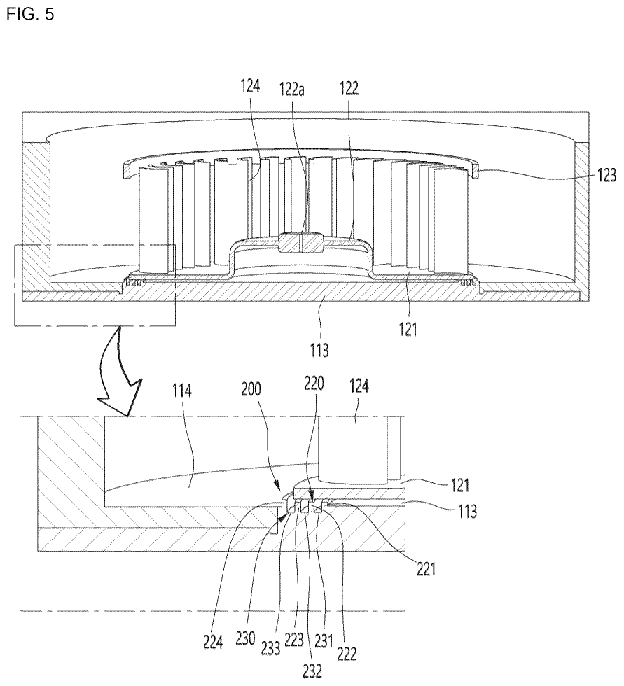

The shaft connecting portion 122 may include an insertion structure into which the motor shaft 125a is inserted. For example, the insertion structure may include a shaft through-hole (122a, see FIG. 5) into which the motor shaft 125a is inserted. The motor shaft 125a may penetrate a protruding portion of the shaft connecting portion 122 and extend downward towards the bottom surface of the shaft connecting portion 122.

The motor shaft 125a may constitute a rotation axis of the fan 120.

The fan 120 may include a rim 123 that is axially spaced from the main plate 121 and a plurality of blades 124 that connect the main plate 12) and the rim 123.

The rim 123 may be ring-shaped. The rim 123 may be parallel to the main plate 121.

The plurality of blades 124 may be configured to have a length in the direction in which the motor shaft 125a extends (up and down in FIG. 3). The plurality of blades 124 may be configured to be arranged in a circumferential direction.

The scroll housing 100 may include a bottom surface on which the fan assembly is placed. The bottom surface may form an opposite surface to a surface on which the orifice 151 is provided. For convenience of explanation, the surface on which the air orifice 151 is provided may be called the “upper surface” of the scroll housing 100, and the bottom surface may be called the “lower surface” of the scroll housing 100.

The bottom surface of the scroll housing 100 forms a fixed portion, and the fan 120 may rotate at a predetermined distance from the bottom surface. Therefore, the fan 120 may not interfere with the bottom surface of the scroll housing 100 during the rotation process.

A flow guide device 200 may be provided on the bottom surface of the scroll housing 100 to guide the flow of air discharged radially outward from the fan 120.

The flow guide device 200 may be placed in a space between the bottom surface of the scroll housing 100 and the fan 120.

The flow guide device 200 may be arranged adjacent to the radially outermost end of the fan 120 to prevent the radially inward flow of the fan 120.

For example, the flow guide device 200 may be arranged adjacent to the edge of the main plate 121 or the radially outermost end of a plurality of blades 124.

The flow guide device 200 may be formed in a circumferential direction so that air around the fan 120 may flow in a circumferential direction along a space between the bottom surface of the scroll housing 100 and the fan unit 120.

The scroll housing 100 may include a plate member 113 and 114 forming the inner surface of the recessed portion 112.

The above plate member 113 and 114 may include a first plate 113 including a part of the bottom surface of the scroll housing 100, for example, a part where the bottom surface of the fan 120 is placed. The first plate 113 may have, for example, a shape of a disc and may constitute the bottom surface of the housing body 110.

The above plate member 113 and 114 may include a second plate 114 forming a circumferential surface of the recessed portion 112, that is, an inner circumferential surface. The second plate 114 may have a cross-section that is folded into an “L” shape.

The second plate 114 may form a surface that circumferentially surrounds the outer side of the flow guide device 200 among the lower surfaces of the recessed portion 112. A part of the second plate 114 forming the lower surface of the recessed portion 112 may be seated on the upper surface of the first plate 113. The lower surface of the recessed portion 112 may constitute the bottom surface of the scroll housing 100.

The lower surface and inner circumferential surface of the recessed portion 112 may be defined by the first and second plates 113 and 114.

The flow guide device 200 may be provided on the plate member 113 and 114. For example, the flow guide device 200 may be provided on the lower surface of the recessed portion 112 and may be provided to protrude upwardly toward the fan 120.

Hereinafter, the configuration of the flow guide device 200 will be described in more detail with reference to the drawings.

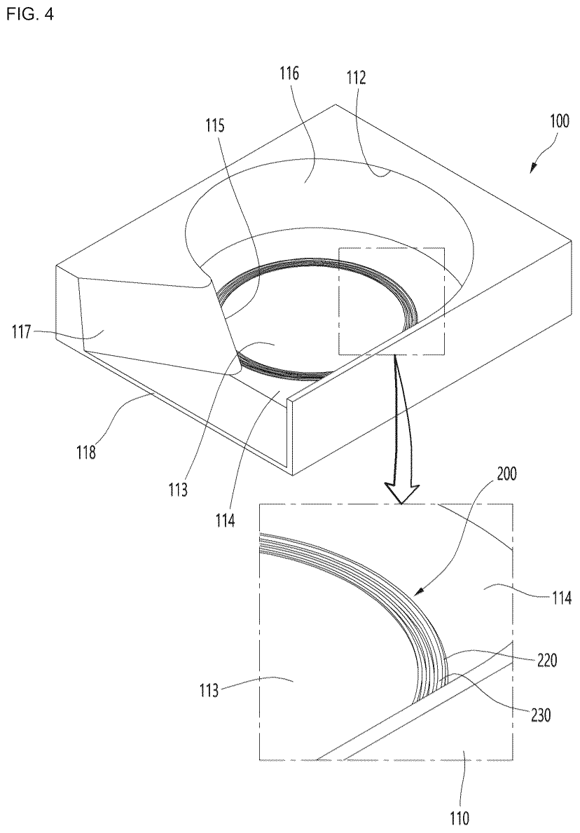

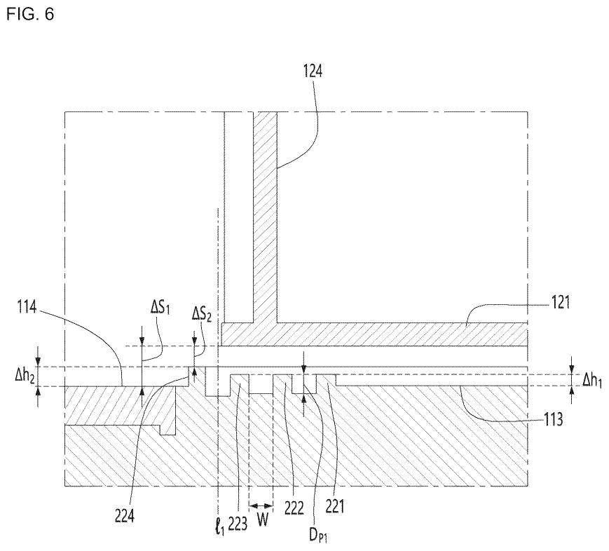

FIG. 4 is a perspective view showing the configuration of the scroll housing according to an embodiment of the present invention, FIG. 5 is a cross-sectional view showing a part of the sirocco fan including the arrangement of the scroll housing and the fan according to an embodiment of the present invention, and FIG. 6 is a cross-sectional view showing a flow guide device provided in a gap between the bottom surface of the scroll housing and the bottom surface of the fan according to an embodiment of the present invention.

Referring to FIGS. 4 to 6, the scroll housing 100 according to an embodiment of the present invention may include a flow guide device 200 to prevent air existing around the fan 120, for example, air passing through the fan 120, from flowing radially inwardly of the fan 120 through the space between the fan 120 and the bottom surface of the scroll housing 100, i.e., from generating vortex.

The air passing through the fan 120 should flow radially outwardly of the fan 120 and be discharged to the outside of the scroll housing 100 through the discharge portion 118. However, if the vortex occurs, the blowing capacity of the sirocco fan may decrease.

Therefore, in order to prevent or reduce such vortex occurring, the flow guide device 200 may be provided in the space between the fan 120 and the bottom surface of the scroll housing 100.

For example, the flow guide device 200 may be provided adjacent to the radially outermost portion of the fan 120.

The flow guide device 200 may be provided adjacent to the radially outermost portion of the fan 120 facing the bottom surface of the scroll housing 100.

The flow guide device 200 may include a structure or shape formed in the circumferential direction so that air passing through the fan 120 may flow in the circumferential direction along the bottom edge of the fan 120.

The flow guide device 200 may include a rib 220 protruding from the bottom surface of the scroll housing 100 in a direction closer to the fan 120.

The bottom surface of the scroll housing 100 may be understood as the lower surface of the recessed portion 112 on which the fan 120 is placed.

The distance between the bottom surface of the scroll housing 100 and the lower end of the fan 120 may be decreased by the protruding rib 220.

The rib 220 may be formed in the circumferential direction of the fan 120 so as to form a flow in the circumferential direction and prevent the occurrence of a radial vortex.

For example, the rib 220 may have a ring shape.

The rib 220 may include a plurality of ribs. The plurality of ribs 220 may include two or more ribs protruding at different heights from the bottom surface of the scroll housing 100.

The plurality of ribs 220 may include a first rib 221 and a second rib 222 surrounding the first rib 221.

Since each of the first and second ribs 221 and 222 is configured to have a ring shape, the second rib 222 may be formed longer than the first rib 221. The direction from the first rib 221 toward the second rib 222 may be a direction toward the radially outer side of the fan 120.

The plurality of ribs 220 may include a third rib 223 surrounding the second rib 222.

Since each of the second and third ribs 222 and 223 is configured to have a ring shape, the third rib 223 may be formed longer than the second rib 222. The direction from the second rib 222 toward the third rib 223 may be a direction toward the radially outer side of the fan 120.

The plurality of ribs 220 may include a fourth rib 224 surrounding the third rib 223.

Since each of the third and fourth ribs 223 and 224 is configured to have a ring shape, the fourth rib 224 may be formed longer than the third rib 223. The direction from the third rib 223 toward the fourth rib 224 may be a direction toward the radially outer side of the fan 120.

In this embodiment, the plurality of ribs 220 are described as including four ribs, but this is not limited thereto, and may include two or three ribs, or may include five or more ribs.

The flow guide device 200 may include a groove 230 formed by recessed into the bottom surface of the scroll housing 100. The direction in which the groove 230 is recessed may correspond to the direction away from the fan part.

The groove 230 may be formed in the circumferential direction of the fan 120 so as to form a flow in the circumferential direction and prevent the occurrence of a radial vortex.

For example, the groove 230 may include a ring-shaped groove.

The groove 230 may include a plurality of grooves 230.

The plurality of grooves 230 may include a first groove 231 and a second groove 232 surrounding the first groove 231.

The first and second grooves 231 and 232 may be separated by a rib 220. The rib 220 may be provided between the first and second grooves 231 and 232.

Since each of the first and second grooves 231 and 232 is configured to have a ring shape, the second groove 232 may be formed longer than the first groove 231. The direction from the first groove 231 toward the second groove 232 may be a direction toward the radially outer side of the fan 120.

The plurality of grooves 230 may include a third groove 233 surrounding the second groove 232.

Since each of the second and third grooves 232 and 233 is configured to have a ring shape, the third groove 233 may be formed longer than the second groove 232. The direction from the second groove 232 to the third groove 233 may be a direction toward the radial outer side of the fan 120.

In the present embodiment, the plurality of grooves 230 are described as including three grooves, but are not limited thereto and may include two grooves or four or more ribs.

The fluid guide device 200 may include a plurality of ribs 220 protruding from the bottom surface of the scroll housing 100 in a direction closer to the fan 120 and a plurality of grooves 230 recessed from the bottom surface in a direction away from the fan 120.

For example, the plurality of ribs 220 may include first to fourth ribs 221, 222, 223 and 224. The plurality of grooves 230 may include first to third grooves 231, 232 and 233.

The plurality of ribs 220 and the plurality of grooves 230 may be arranged alternately in the radial direction.

Any one of the plurality of ribs 220 may be arranged to surround any one of the plurality of grooves 230.

For example, the second rib 222 may be arranged to surround the first groove 231.

The third rib 223 may be arranged to surround the second groove 232.

The fourth rib 224 may be arranged to surround the third groove 233.

Any one of the plurality of grooves 230 may be arranged to surround any one of the plurality of ribs 220.

For example, the first groove 231 may be arranged to surround the first rib 221.

The second groove 232 may be arranged to surround the second rib 222.

The third groove 233 may be arranged to surround the third rib 223.

A rib provided at the radially outermost side of the plurality of ribs 220, i.e., the fourth rib 224, may have a greater protruded height than the other ribs 221, 222 and 223.

The fourth rib 224 may correspond to the inlet side rib of the vortex when the vortex occurs. That is, the vortex flows toward the center of the fan 120 through the space between the radially outermost part of the fan 120 and the bottom surface of the scroll housing 100, and at this time, the flow direction may correspond to the direction from the fourth rib 224 toward the first rib 221.

Since the fourth rib 224 has the largest protruded height, the distance between the fan 120 and the bottom surface of the scroll housing 100 on the fourth rib 224 side may be the shortest. Therefore, the phenomenon of the vortex acting in the space between the fan 120 and the bottom surface of the scroll housing 100 may be reduced.

In detail, referring to FIG. 6, the bottom surface of the scroll housing 100 and the bottom surface of the fan 120 facing the bottom surface of the scroll housing 100 can be spaced apart by a first distance (ΔS1). The bottom surface of the scroll housing 100 may be defined by the first and second plates 113 and 114 and may form the lower surface of the recessed part 112.

The plurality of ribs 221, 222, 223 and 224 may protrude from the bottom surface of the scroll housing 100 toward the bottom surface of the fan 120 by a predetermined height.

Except for the fourth rib 224, the first to third ribs 221, 222 and 223 may protrude by a first height (Δh1). The fourth rib 224 may protrude by a second height (Δh2) greater than the first height (Δh1).

Since the protruded height of the fourth rib 224 provided at the outermost side in the radial direction among the plurality of ribs is formed to be the largest, the distance (ΔS2, second distance) between the fourth rib 224 and the fan 120 may be reduced. Accordingly, the possibility of generating the vortex toward the center of the fan 120 through the fourth rib 224 may be reduced.

A groove 230 may be formed between the two most adjacent ribs among the plurality of ribs 220. The depth at which the groove 230 is recessed from the bottom surface of the scroll housing 100 may form a first depth (ΔDp1).

The width at which the groove 230 is recessed in the radial direction may form a first width (W1).

The flow guide device 200 may be configured to have a predetermined length in the radial direction.

The radially innermost part of the flow guide device 200, i.e., the first rib 221, may be positioned radially inwardly relative to the radially outermost part of the fan 120.

The radially outermost part of the flow guide device 200, i.e., the fourth rib 224, may be positioned radially outwardly relative to the radially outermost part of the fan 120.

An axial extension line ( [symbol] 1) passing through the radially outermost part of the fan 120 may be configured to pass through the flow guide device 200.

The extension line ( [symbol] 1) may be positioned radially inwardly relative to the fourth rib 224, which is the outermost part of the flow guide device 200.

For example, the extension line ( [symbol] 1) may pass through the third groove 233.

In this way, the flow guide device 200 is provided adjacent to the radially outermost portion of the fan 120 and is configured to extend inward and outward with respect to the radially outermost portion of the fan 120, so that the generation of the vortex at the radially outermost portion of the fan 120 may be suppressed.

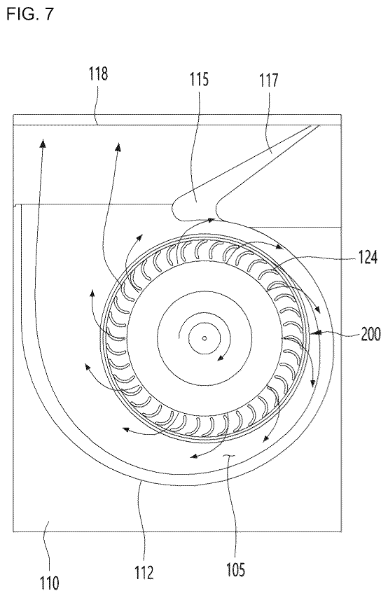

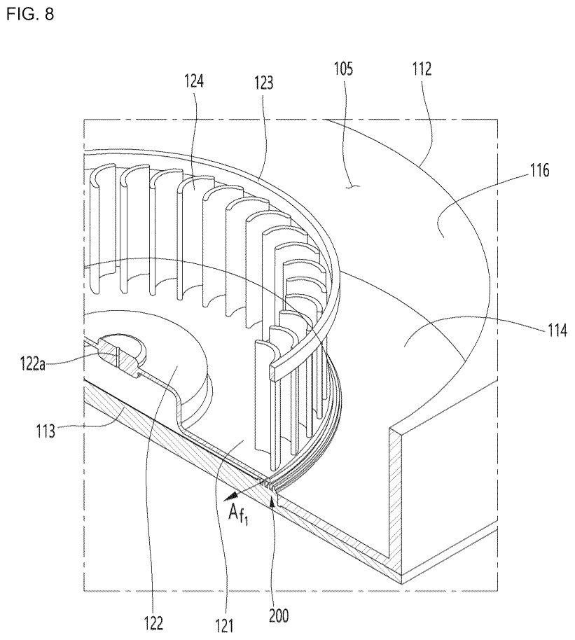

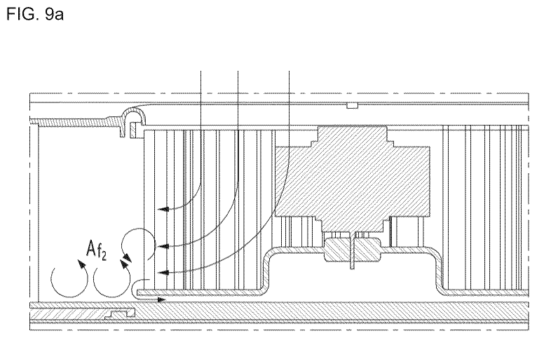

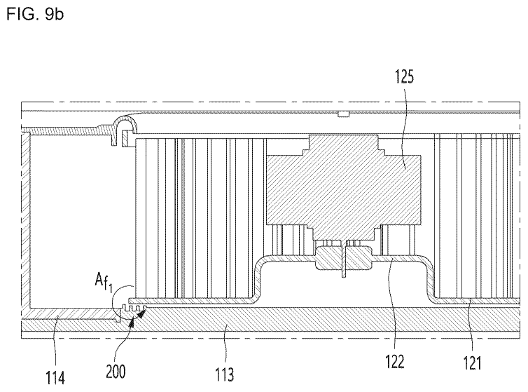

FIG. 7 is a plan view showing a flow appearance in the sirocco fan according to an embodiment of the present invention, FIG. 8 is a cross-sectional view showing a flow appearance in a circumferential direction through the flow guide device according to an embodiment of the present invention, FIG. 9a is a cross-sectional view showing a flow appearance in the sirocco fan not provided with the flow guide device according to an embodiment of the present invention, and FIG. 9b is a cross-sectional view showing a flow appearance in the sirocco fan provided with the flow guide device according to an embodiment of the present invention.

Referring to FIGS. 7 and 8, the air flow generated by the operation of the sirocco fan will be described.

When the operation of the sirocco fan 10 according to the embodiment of the present invention starts, the fan motor 125 is driven and the fan 120 rotates so that air may be sucked into the sirocco fan 10.

The outside air of the sirocco fan 10 is sucked through the suction portion (155), and the sucked air is introduced in the axial direction of the fan 120. The air passing through the fan 120 is discharged in the radial direction and flows toward the discharge guide 117 via the fan path 105.

The air may be discharged to the outside of the scroll housing 100 through the discharge part 118.

In this process, at least a portion of the discharged air may form a flow (Af1) in the circumferential direction along the flow guide device 200. The flow (Af1) may be formed by being guided by the circumferential rib 220 and the circumferential groove 230 provided in the flow guide device 200.

The rib 220 protrudes from the bottom surface of the scroll housing 100 to reduce the size of space between the bottom surface of the fan 120 and the bottom surface of the scroll housing 100, thereby preventing the air flowing through the fan path 105 from flowing in the inner radial direction of the fan 120 through the space between the bottom surface of the fan 120 and the bottom surface of the scroll housing 100.

In detail, FIG. 9a shows the configuration of the sirocco fan when the flow guide device according to the present invention is not provided.

In the process of air passing through the sirocco fan and being discharged in the outer radial direction of the fan, a vortex (Af2) may occur as a disturbing flow to the discharge flow in the space adjacent to the bottom surface of the fan 120 and the bottom surface of the scroll housing 100.

The vortex (Af2) may act as a resistance to the discharge flow, thereby reducing the air volume of the fan and deteriorating the fluidity performance.

In order to prevent this phenomenon, as shown in FIG. 9b, the present invention may include a flow guide device 200.

The flow guide device 200 is arranged at a position adjacent to the bottom surface of the fan 120 and the bottom surface of the scroll housing 100, for example, in the space between the bottom surface of the fan 120 and the bottom surface of the scroll housing 100, thereby preventing the occurrence of a disturbance flow in the inner radial direction through the space.

By suppressing the occurrence of such the disturbance flow, the air volume of the sirocco fan may be increased and the fluidity performance may be improved.

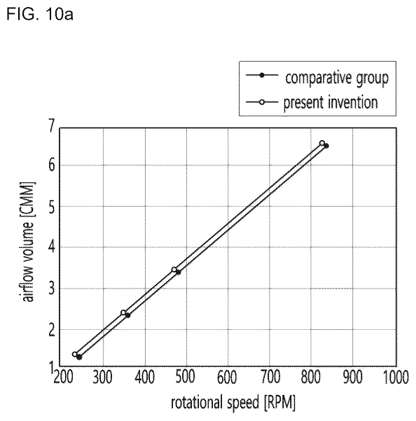

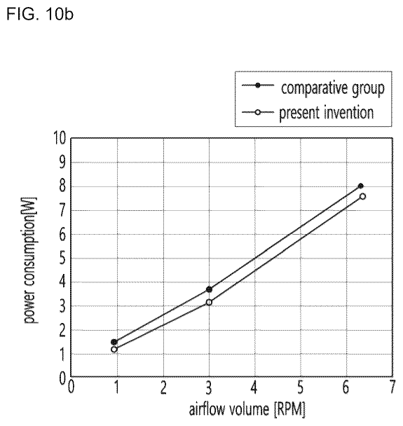

FIG. 10a is an experimental graph showing a comparison between a sirocco fan (comparative group) according to FIG. 9a and a sirocco fan according to the present invention in terms of the change in airflow volume relative to the rotational speed of the fan, and FIG. 10b is an experimental graph showing a comparison between a sirocco fan (comparative group) according to FIG. 9a and a sirocco fan according to the present invention in terms of the change in power consumption relative to the airflow volume of the fan.

First, referring to FIG. 10a, it may be seen that the discharged airflow volume increases as the rotational speed of the fan part 120 increases.

In FIG. 10a, the comparative group shows the change in the airflow volume in the sirocco fan 10 in the structure according to the FIG. 9a. On the other hand, the structure as FIG. 9b shows the change in the airflow volume in the sirocco fan 10 equipped with the flow guide device 200 according to an embodiment of the present invention.

When comparing the two lines shown in FIG. 10a, it may be seen that the airflow volume in the sirocco fan according to the present invention increases by about 5% or more compared to the comparative group.

Next, referring to FIG. 10b, it may be seen that the power consumption increases as the airflow volume increases due to the operation of the fan 120.

In FIG. 10b, the comparison group shows the change in power consumption in the sirocco fan 10 in the structure according to the FIG. 9a. On the other hand, the structure as FIG. 9b shows the change in power consumption in the sirocco fan 10 equipped with the flow guide device 200 according to the embodiment of the present invention.

When comparing the two lines shown in FIG. 10b, it may be seen that the power consumption in the sirocco fan according to the present invention decreases by about 8% or more compared to the comparison group.

As can be seen from the graphs of FIG. 10a and FIG. 10b, by equipping the sirocco fan with the flow guide device 200 according to the embodiment of the present invention, the discharged airflow volume relative to the rotational speed of the fan increases, and the power consumption may be relatively reduced.

### INDUSTRIAL APPLICABILITY

According to an embodiment of the present invention, since a flow guide device is provided in the sirocco fan, unwanted disturbance flow can be prevented from occurring in the flow discharged through the fan and flow loss may be reduced. Therefore, the industrial applicability is remarkable.

1. A sirocco fan comprising:
a scroll housing having an axial suction portion and a radial discharge portion and including a bottom surface;
a fan that is placed on the bottom surface of the scroll housing and includes a plurality of blades arranged in a circumferential direction;
a fan motor including a motor shaft coupled to the fan; and
a flow guide device that is provided in a space between the bottom surface of the scroll housing and the fan and is arranged in a circumferential direction so as to suppress the generation of flow toward the center of the fan in air flowing toward the discharge portion.

2. The sirocco fan according to claim 1, wherein the fan includes a main plate coupled to the motor shaft, and
wherein the flow guide device is provided between the main plate of the fan and the bottom surface of the scroll housing.

3. The sirocco fan according to claim 2, wherein the plurality of blades are arranged in a circumferential direction of the main plate, and
wherein the flow guide device is provided at a position adjacent to the edge of the main plate or adjacent to the radially outermost end of the plurality of blades.

4. The sirocco fan according to claim 2, wherein the flow guide device is provided on the bottom surface of the scroll housing, and includes a rib protruding toward the main plate of the fan, and
wherein the rib extends in a circumferential direction along the edge of the fan.

5. The sirocco fan according to claim 4, wherein the rib includes a plurality of ribs extending in a circumferential direction, and
wherein at least one rib among the plurality of ribs is provided further outward than the radially outermost end of the fan, and the other rib is provided further inward than the radially outermost end of the fan.

6. The sirocco fan according to claim 5, wherein the plurality of ribs includes a first rib extending in a circumferential direction and a second rib surrounding the first rib and extending in a circumferential direction.

7. The sirocco fan according to claim 2, wherein the flow guide device includes a groove formed on the bottom surface of the scroll housing and recessed in a direction away from the main plate of the fan, and
wherein the groove is formed in a circumferential direction of the fan.

8. The sirocco fan according to claim 7, wherein the groove includes a plurality of grooves formed in a circumferential direction, and
wherein at least one groove among the plurality of grooves is formed further outward than a radially outermost end of the fan, and the other groove is formed further inward than a radially outermost end of the fan.

9. The sirocco fan according to claim 8, wherein the plurality of grooves include a first groove formed in a circumferential direction and a second groove surrounding the first groove and formed in a circumferential direction.

10. The sirocco fan according to claim 2, wherein the flow guide device comprises:
a plurality of ribs provided on the bottom surface of the scroll housing and protruding toward the main plate of the fan; and
a plurality of grooves recessed from the bottom surface of the scroll housing.

11. The sirocco fan according to claim 10, wherein the plurality of ribs and the plurality of grooves are arranged alternately in the radial direction.

12. The sirocco fan according to claim 11, wherein the plurality of ribs include a first rib and a second rib extending in the circumferential direction, and
wherein the plurality of grooves include a first groove formed in the circumferential direction between the first and second ribs.

13. The sirocco fan according to claim 11, wherein when defining an axial extension line ( [symbol] 1) passing through the radially outermost portion of the fan, the axial extension line is configured to pass through the flow guide device.

14. The sirocco fan according to claim 13, wherein the extension line is located further radially inward than the rib provided on the outermost part of the flow guide device, and is configured to pass through one among the plurality of grooves.

15. The sirocco fan according to claim 1, wherein the scroll housing includes:
a scroll inner circumferential portion surrounding the fan;
a discharge guide extending from the scroll inner circumferential portion in a tangential direction of the fan; and
a cut-off formed at a portion where the scroll inner circumferential portion and the scroll discharge guide meet and defining a boundary between a discharge and a re-suction of air flow.

16. A sirocco fan comprising:
a scroll housing having an axial suction portion and a radial discharge portion and including a bottom surface;
a fan including a plurality of blades arranged in a circumferential direction and placed on the bottom surface of the scroll housing;
a plurality of ribs provided in a space between the floor surface and the fan and arranged in a circumferential direction so as to suppress the occurrence of a flow toward the center of the fan among air flowing toward the discharge portion; and
a groove formed between the plurality of ribs.

17. The sirocco fan according to claim 16, wherein the plurality of ribs protrude axially from the bottom surface of the scroll housing toward the fan.

18. The sirocco fan according to claim 16, wherein the plurality of ribs are provided in an edge area of the fan.

19. The sirocco fan according to claim 16, wherein the plurality of ribs include a first rib extending in the circumferential direction of the fan and a second rib surrounding the first rib and extending in the circumferential direction, and wherein the second rib is provided further outward than the radially outermost end of the fan, and the first rib is provided further inward than the radially outermost end of the fan.

20. The sirocco fan according to claim 19, wherein the height at which the first rib protrudes from the bottom surface of the scroll housing is greater than the height at which the second rib protrudes from the bottom surface of the scroll housing.
